(19) United States
(12) Patent Application Publication
(10) Pub. No.: US 2005/0041301 A1
(43) Pub. Date: Feb. 24, 2005

(54) Lens device

(75) Inventor: Hiroshi Kibayashi, Niiza-shi (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA OPTO, INC.

(21) Appl. No.: 10/916,399

(22) Filed: Aug. 12, 2004

(30) Foreign Application Priority Data
Aug. 19, 2003 (JP) JP2003-294793

(51) Int. Cl. G02B 1/06; G02B 3/12

(52) U.S. Cl. 359/666

(57) ABSTRACT

In a lens device provided with a liquid optical element in which the conductive or polar first liquid and the second liquid which is not mixed with the first liquid each other, are sealed and housed in a container so that an interface has a predetermined shape, and when the voltage is impressed between the first liquid and an electrode provided on the container, a shape of the interface is changed and a refractive power is adjusted, because the present invention is characterized in that it has: a plastic lens whose optical characteristic is changed due to the temperature; a temperature detection means for detecting the temperature; and a control means for controlling the voltage to be impressed on the liquid optical element, corresponding the temperature detected by the temperature detection means, so that the influence due to the change of the optical characteristic of the plastic lens and the liquid optical element is decreased, irrespective of the temperature change, the dislocation of the image-formation position to a predetermined image-formation surface can be removed.

### RELATED APPLICATION

This application is based on patent application(s) No(s). 2003-294793 filed in Japan, the entire content of which is hereby incorporated by reference.

### BACKGROUND

1. Field of the Invention

The present invention relates to a optical lens system, and to a optical lens system appropriate when it is used for a small type image pick-up device mounted on, for example, a silver halide camera, electronic camera, or cell phone.

2. Description of the Related Art

In a small type image pick-up device mounted on a silver halide camera, electronic camera, or cell phone, a lens device for image-forming an optical image on a film surface or image pick-up element is provided. Herein, when a lens to be used for the lens device is formed of plastic material, by using the injection molding, mass production can be conducted at low cost, and the production cost can be suppressed low.

Hereupon, in the plastic material, change of the physical characteristic to the environmental change is larger than the inorganic glass material. For example, a linear expansion coefficient is large, and in PMMA as the plastic material, in comparison with that this linear expansion coefficient is 67.9×10⁻⁶/° C. in the central value, in LaK14 of the inorganic glass(made by OHARA), this is 57×10⁻⁷/° C., and smaller by 1. Further, also relating to change of the refractive index to the temperature change, in PMMA, as compared with 1.0−1.2×10⁻⁴/°° C. in the central value, in the LaK14, it is 3.9−4.4×10⁻⁶/° C. in D line, and smaller by 2 place.

As described above, the plastic material is, as compared to the inorganic glass material, a change of optical constants (refractive index or shape) to the temperature change is large. For example, in a lens formed of the plastic material, so called plastic lens, as compared to a lens formed of inorganic glass material, the focal distance is largely changed to the temperature change.

Particularly, in the recent lens device, the size reduction of a photographic optical system, size reduction of a solid image pick-up element, and high densification of each factor are intended, and the device is in a tendency which is down-sized. Therefore, to a predetermined image-formation surface in the lens device, there is a problem that the influence of dislocation of the image-formation surface due to the temperature change become large as much as it can not be neglected. Accordingly, it is a large problem how the dislocation of the image-formation position due to such an environmental change is effectively corrected.

To cope with such a problem, conventionally, a counter measure that a convex lens and a concave lens, which are the same plastic, are used in combination, and the characteristic change of both lenses due to the temperature change are cancelled out, or that the dislocation amount of the image-formation position due to the temperature change is previously measured and stored, and at the time of focusing drive, by correcting the optical axis direction position of the plastic lens, irrespective of the temperature, the dislocation of image-formation position to the predetermined image-formation surface is removed, is considered.

However, according to the counter measure of the former, although it is effective for the lens device whose number of plastic lenses is many, but for the lens device whose number of lenses is few and the plastic lens is used frequently, the degree of freedom of the design work of the optical system is limited, and it can hardly be said that the optimum optical characteristic can always be obtained. On the one hand, according to the counter measure of the latter, there is a problem that it is necessary that the high accurate moving mechanism (high resolving power moving mechanism) to drive the plastic lens is provided in the lens device, and the structure becomes complex, resulting in an increase of cost.

In contrast to this, in U.S. Pat. No. 6,369,954B1, a liquid optical element in which the conductive or polar first liquid, and the second liquid which is not mixed with the first liquid are sealed and housed in a container so that a interface is a predetermined shape, and when the voltage is impressed between the first liquid and the electrode provided in the container, the shape of the interface is changed and the refractive power is corrected, is disclosed. Accordingly, when the plastic lens and the liquid optical element are used in combination, also without compelling the plastic lens to be displaced in the optical axis direction, when the liquid optical element is controlled so that the optical characteristic change generated due to the temperature change is negated, it can also be said that the optical image can be appropriately image-formed on the predetermined image-formation surface.

However, also in the liquid optical element, a change of the optical characteristic corresponding to the temperature change is generated. Accordingly, simply, only in the case where the plastic lens and the liquid optical element are combined, it can not be said that the lens device in which the dislocation of the image-formation position to the predetermined image-formation surface is negated irrespective of the temperature change, can be provided.

### SUMMARY

The object of the present invention is to solve the above-described problems. That is, it is to provide a lens device in which, irrespective of the change of temperature, a dislocation of the image-formation position to a predetermined image-formation surface is removed.

Further, a optical lens system comprising: a liquid optical element including: a first liquid having conductivity, a second liquid, which is insoluble to the first liquid, a sealing container sealing the first liquid and the second liquid so that an interface of the first liquid and the second liquid has a predetermined shape, a first electrode provided in the first liquid, a second electrode provided in the sealed container, and a voltage-applying device to apply a voltage between the first electrode and the second electrode for changing the shape of the interface of the first liquid and the second liquid so as to change a refractive power of the liquid optical element; a plastic lens having an optical characteristic being capable of varying due to a temperature change; a temperature detector to detect a temperature of a predetermined portion in the optical lens system; and a voltage-controlling device to control the voltage in accordance with the temperature detected by the temperature detector so that an influence due to a change of the optical characteristic of the plastic lens and the liquid optical element is decreased, irrespective of the temperature change, a dislocation of the image-formation position to the predetermined image-formation surface can be removed.

Further, a optical lens system comprising: a liquid optical element including: a first liquid having conductivity, a second liquid, which is insoluble to the first liquid, a sealing container sealing the first liquid and a second liquid so that an interface of the first liquid and the second liquid has a predetermined shape, a first electrode provided in the first liquid, a second electrode provided in the sealed container, and a voltage-applying device to apply a voltage between the first electrode and the second electrode for changing the shape of the interface of the first liquid and the second liquid so as to change a refractive power of the liquid optical element; a plastic lens having an optical characteristic being capable of varying due to a temperature change; an electrostatic capacity detector to detect a electrostatic capacity of a predetermined portion in the liquid optical element; and a voltage-controlling device to control the voltage in accordance with the electrostatic capacity detected by the electrostatic capacity detector so that an influence due to the change of the optical characteristic of the plastic lens and the liquid optical element is decreased, when the temperature is found from the electrostatic capacity of the liquid optical element, the control means conducts the voltage control corresponding to it, and thereby, irrespective of the temperature change, a dislocation of the image-formation position to the predetermined image-formation surface can be removed.

The invention itself, together with further objects and attendant advantages, will best be understood by reference to the following detailed description taken in conjunction with the accompanying drawings.

### BRIEF DESCRIPTION OF THE DRAWINGS

FIG. 1 is a sectional view of a liquid optical element used for a optical lens system according to an embodiment of the present invention, FIG. 2 is a sectional view of a liquid optical element used for a optical lens system according to an embodiment of the present invention, FIG. 3 is a outline structural view of an electronic camera 50 in which the optical lens system 40 including a liquid optical element 1 is adopted, FIG. 4 is a flow chart of a control which is conducted by a CPU 30 of the electronic camera 50 shown in FIG. 3, FIG. 5 is an outline structural view of an electronic camera 150 according to an embodiment in FIG. 2.

In the following description, like parts are designated by like reference numbers throughout the several drawings.

### DESCRIPTION OF THE PREFERRED EMBODIMENT

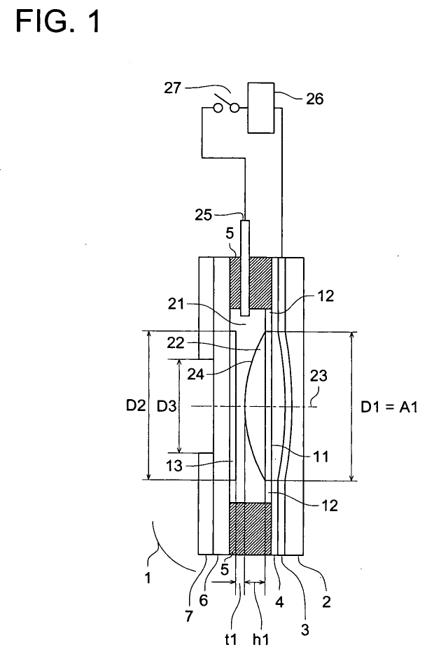

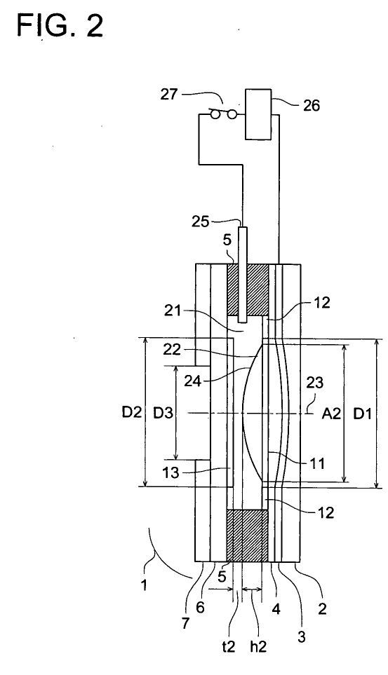

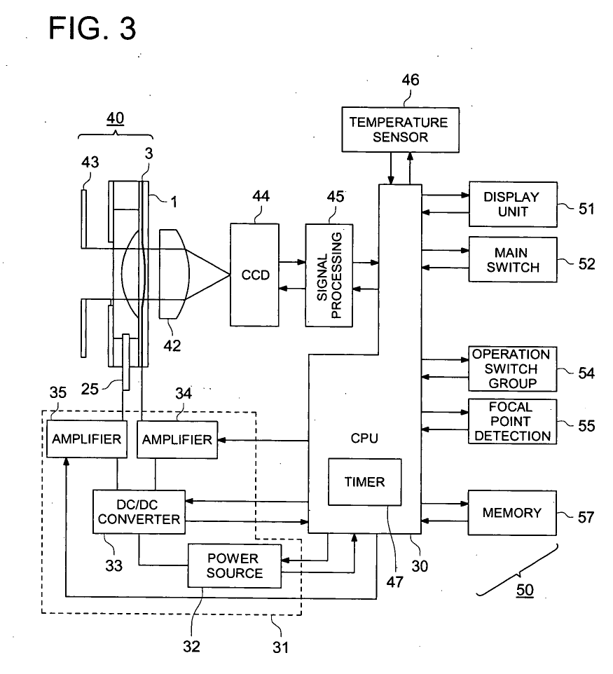

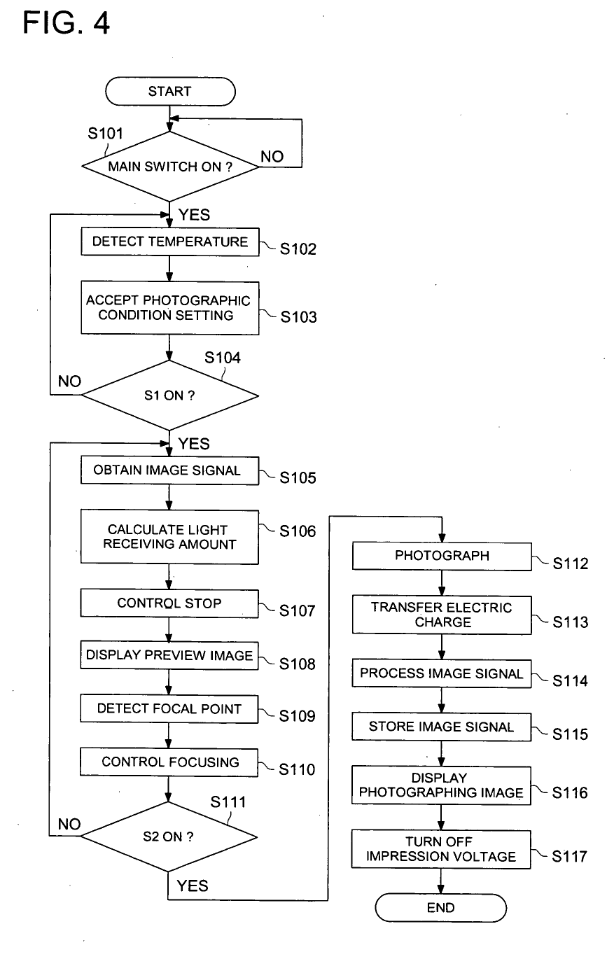

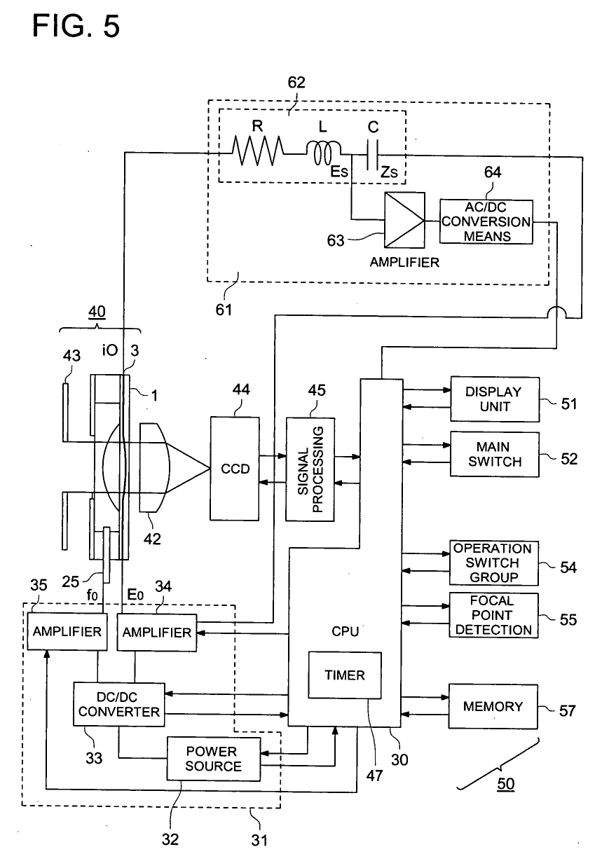

FIGS. 1, 2 are sectional views of a liquid optical element used for a optical lens system according to embodiments of the present invention. By using FIG. 1, a structure and an operation of the liquid optical element will be described below. In FIG. 1, numeral 1 shows the whole of optical elements of the present invention, and numeral 2 is a transparent substrate formed of a transparent acrylic material in which a concave portion is provided in its center. On an upper surface of the transparent substrate 2, an indium tin oxide transparent electrode (ITO) is formed by spattering, and on the upper surface, a transparent acrylic insulation layer 4 is provided with adherence. The insulation layer 4 is formed in such a manner that a replica resin is dropped in the center of the transparent electrode 3, and after this is pressed by a glass plate and its surface is flattened, UV irradiation is conducted and it is hardened. On the upper surface of the insulation layer 4, a cylindrical container 5 having the light tightness is adhered and fixed, on its upper surface, a transparent acrylic cover plate 6 is adhered and fixed, and further on its upper surface, a stop plate 7 having an aperture of diameter D3 in the central portion is arranged. In the structure as described above, a sealed space of a predetermined volume surrounded by the insulation layer 4, container 5 and upper cover 6, that is, a casing having a liquid chamber is formed. Then, on a wall surface of the liquid chamber, the surface processing shown by the following is conducted.

Initially, on the central upper surface of the insulation layer 4, a water repellent processing agent is coated in a range of the diameter D1, and a water repellent film 11 is formed. As the water repellent processing agent, fluorine compound is suitable. Further, in a range outside the diameter D1 on the upper surface of the insulation layer 4, a hydrophilic processing agent is coated, and a hydrophilic film 12 is formed.

As the hydrophilic agent, an interface active agent, or hydrophilic polymer is suitable. On the one hand, on the lower surface of the cover plate 6, a hydrophilic processing is conducted in a range of a diameter D2, and a hydrophilic film 13 having the same character as the hydrophilic film 12 is formed. Then, all structural members described above, have a rotation symmetric shape about an optical axis 23. Further, a hole is formed in a portion of the container, and a bar-like electrode 25 is inserted herein, and sealed by an adhesive agent, and the shielding property of the liquid chamber is maintained. Then, the system is structured in such a manner that an electric feeding means 26 is connected to the transparent electrode 3 and the bar-like electrode 25, and a predetermined voltage can be impressed between both electrodes by an operation of a switch 27.

In the liquid chamber structured as described above, 2 kinds of liquids shown below are filled up. Initially, on the water repellent film 11 on the insulation layer 4, a second liquid. 22 is dropped in a predetermined amount. The second liquid 22 is colorless and transparent, and a silicon oil whose specific weight is 1.06 and refractive index is 1.45 at the room temperature, is used. On the one hand, in the remained space in the liquid chamber, a first liquid 21 is filled up. The first liquid 21 is an electrolytic solution in which water and ethyl alcohol are mixed in a predetermined rate, and further, a predetermined amount of salt is added, and whose specific weight is 1.06, and refractive index is 1.35 at the room temperature.

That is, as the first and the second liquids, liquids whose specific weight is equal and in which they are insoluble each other, are selected. Therefore, both liquids form the interface 24, and are not mixed each other, and each liquid exists independently.

Next, the shape of the interface will be described. Initially, when the voltage is not impressed on the first liquid, the shape of the interface 24 is determined by: an interface tension between both liquids; interface tension between the first liquid, and the water repellent film 11 on the insulation layer 4 or hydrophilic film 12; and a volume of the second liquid. In the present embodiment, a material selection is conducted so that an interface tension between silicon oil which is a material of the second liquid 22 and the water repellent film 11 relatively becomes small. That is, because the wettability between both materials is. high, a periphery of a lens-shaped liquid drop which is formed of the second liquid 22 has a characteristic to spread, and becomes stable at a portion at which the periphery is coincident with the coating range of the water repellent film 11. That is, a diameter Al of the lens bottom surface formed of the second liquid is equal to a diameter D1 of the water repellent film 11. On the one hand, because the specific weight of both liquids is equal as described above, the gravity does not act. Accordingly, the interface 24 becomes spherical surface, and its radius of curvature and the height h1 are determined by a volume of the second liquid 22. Further, the thickness on the optical axis of the first liquid is t1.

On the one hand, a switch 27 is close-operated, and when the voltage is impressed on the first liquid 21, the interface tension between the first liquid 21 and hydrophilic film 12 is decreased by the electric capillary phenomenon, and the first liquid invades in the water repellent film 11 riding across the border between the hydrophilic film 12 and the water repellent film 11. As the result, as shown in FIG. 2, the diameter of the lens formed of the second liquid is decreased from A1 to A2, and the height is increased from h1 to h2. Further, the thickness on the optical axis of the first liquid is t2. In this manner, when the voltage is impressed onto the first liquid 21, a balance of the interface tension between 2 kinds of liquids is changed, and the shape of the interface between both liquids is changed. Accordingly, an optical element in which the shape of the interface 24 can be freely changed by the voltage control of the electric feeding means 26, can be realized. Further, because the first liquid and the second liquid have different refractive indexes, the power as the optical lens is given, accordingly, the liquid optical element 1 becomes a variable focal point lens by the change of shape of the interface 24. Further, because the radius of curvature of the interface 24 of FIG. 2 is shorter than that of FIG. 1, the focal distance of the liquid optical element 1 of the situation in FIG. 2, is shorter than that of FIG. 1.

FIG. 3 is an outline structural view of an electronic camera 50 in which a optical lens system 40 including the liquid optical element 1 is adopted.

In the present embodiment, the electronic camera 50 is defined as a so-called digital still camera by which a still image is photoelectrically converted into an electric signal through an image pick-up element, and it is stored as a digital data, however, it is not limited to this. The lens device 40 is structured in order from the object side, by including a stop unit 43, liquid optical element 1, and plastic lens 42, further, temperature sensor 46, CPU 30 which is a control means, and electric feeding means 31. The plastic lens 42 is fixed in the optical axis direction, and the focal point adjustment is conducted by a power change of the liquid optical element 1. In the stop unit 43, the aperture diameter is adjusted by a well-known engineering, and the light amount of the photographic light flux is adjusted. Further, at the focal point position (a predetermined image-formation surface) of the lens device 40, an image pick-up element 44 is arranged. For this, a plurality of photoelectric conversion sections by which an optical image image-formed on the light receiving surface is converted into electric charges, electric charge accumulation section for accumulating the electric charges, and photoelectric conversion means such as secondary dimensional CCD formed by electric charge transmission section by which the electric charge is transferred and sent to the outside, are used.

The electric feeding means 31 to control the power of the liquid optical element 1 will be described below. Numeral 32 is a DC power source such as a dry buttery assembled in the electronic camera 50, numeral 33 is a DC/DC converter by which the voltage outputted from the power source 32 is boosted-up to a desired voltage value corresponding to a control signal of CPU 30, and numerals 34 and 35 are amplifiers by which a control signal of the CPU 30, for example, corresponding to a frequency/duty ratio variable signal, its signal level is amplified up to a voltage level boosted-up by the DC/DC converter 33. Further, the amplifier 34 is connected to the transparent electrode 3 of the liquid optical element 1, and the amplifier 35 is connected to the bar-like electrode 25 of the liquid optical element 1. That is, corresponding to a control signal of CPU 30, the output voltage of the power source 32 is impressed on the liquid optical element 1 at a desired voltage value, frequency, and duty by the DC/DC converter 33, amplifier 34 and amplifier 35.

Numeral 45 is an image signal processing circuit, and an analog image signal inputted from the image pick-up element 44 is A/D converted, and it conducts an image processing such as AGC control, white balance, γ correction, and edge emphasis. Numeral 46 is a temperature detection means for measuring the atmospheric temperature (ambient temperature) of the periphery of the lens device 40, that is, a temperature sensor. Numeral 47 is a timer provided inside CPU 30, and for counting a time set by the CPU 30. Numeral 51 is a display unit such as a liquid crystal display, and displays the subject image obtained by the image pick-up element 44, or an operational status of the optical device having a variable focal point lens. Numeral 52 is a main switch for starting the CPU 30 from a sleep condition to a program executing condition. Numeral 54 is an operation switch group other than the above switch, and is structured by a photographing preparing switch, photographing start switch, and photographing condition set switch for setting a shutter second time. Numeral 55 is a focal point detection means, and the phase difference detection type focal point detection means used for a single-lens reflex camera is suitable. Numeral 57 is a memory means for storing a photographed image signal. Specifically, a detachable PC card type flash memory is suitable.

An operation of the present embodiment will be described below. FIG. 4 is a flowchart of a control which is conducted by the CPU 30 of the electronic camera 50 shown in FIG. 3. In step S101, a CPU 30 judges whether the main switch is On-operated, and when it is not On-operated, a condition of a stand-by mode in which an operation of each kind of switches is waited as it is, is maintained. In step S101, when the main switch 52 is judged that it is On-operated, the CPU 30 cancels the stand-by mode, and advances to on and after the next step S102.

In step 102, the ambient temperature of the lens device 40 of the electronic camera 50, that is, the temperature of periphery of the plastic lens 42 and liquid optical element 1 is measured by the temperature sensor 46. In step S103, the CPU 30 accepts the set of the photographic condition by the photographer (for example, set of the exposure control mode (shutter priority AE, program AE) or image quality mode (large and small of the number of recording pixel, large and small of the image compression ratio), strobe mode (compulsive light emission, light emission inhibition)).

In step S104, the CPU 30 judges whether the semipressing operation (S1 On) of the release switch is conducted. When S1-On operation is not conducted, the sequence returns to S102, and the acceptance of the temperature detection and photographic condition set is repeated. In step 104, when it is judged that S1-On operation is conducted, the sequence moves to step S105, and the CPU 30 drives the image pick-up means 44 and signal processing circuit 45, and obtains a preview image. The preview image means an image obtained before photographing in order to make the photographer grasp the photographic framing.

In step S106, the CPU 30 recognizes the light receiving level of the preview image obtained in step S105. Specifically, in the image signal outputted by the image pick-up means 44, the output signal level of the maximum, minimum, and average is calculated, and the light amount incident on the image pick-up means 44 is recognized. In step S107, the CPU 30 drives the stop unit 43 provided in the lens device 40, according to the light receiving amount recognized in step S106, and adjusts the aperture diameter of the stop unit 43 so that the light amount becomes appropriate.

In step S108, the CPU 30 displays the preview image obtained in step S105 on a display unit 51, and continually, in step S109, detects the distance to the object by using the focal point detecting means 55, further, in step S110, drive controls the liquid optical element 1, and obtains the optimum focus status. At this time, because the refractive index of the plastic lens 42 is changed corresponding to the temperature, and further, the refractive index of the liquid optical element 1 is also changed, the CPU 30 changes the voltage value to impress on the liquid optical element 1 according to a table shown in Table 1, according to the object distance obtained by the focus detecting means 55 and the temperature obtained by the temperature sensor 46. Thereby, the influence of the optical characteristic change due to the temperature of a plastic lens 42 and liquid optical element 1 is decreased, and an appropriate focus operation can be realized.

TABLE 1

**

| *1 | 1 m | 2 m | 4 m | 8 m | 16 m | ∞ |
|---|---|---|---|---|---|---|
| 0° C. | 200 | 180 | 160 | 150 | 140 | 130 |
| 10° C. | 198 | 178 | 158 | 148 | 138 | 128 |
| 20° C. | 196 | 176 | 156 | 146 | 136 | 126 |
| 30° C. | 193 | 173 | 153 | 143 | 133 | 123 |
| 40° C. | 190 | 170 | 150 | 140 | 130 | 120 |

(Note)
**: object distance
*1: temperature

After that, the sequence advances to step S111, the CPU 30 judges whether an operation of the full-pressing (S2 on) of the release switch is conducted. When a S2-On operation is not conducted, the sequence returns to step S105, and the steps from the acquisition of the preview image to the focus drive are repeatedly conducted.

On the one hand, when the photographer operates the release switch S2-on, the CPU 30 conducts the photographing in step S112. That is, the object image image-formed on the light receiving surface of the image pick-up means 44 is photoelectric converted, and the electric charges proportional to the intensity of the optical image are accumulated in the electric charge accumulation section in the vicinity of each light receiving section. In step S113, the CPU 30 reads the electric charge accumulated in step S112 through a electric charge transfer line, and a read analog signal is inputted to a signal processing circuit 45. In step S114, in the signal processing circuit 45, an inputted analog image signal is A/D converted, and an image processing such as an AGC control, white balance, γ correction, and edge emphasis, is conducted, and further, at need, JPEG compression is conducted by an image compression program stored in the CPU 30. In step S115, the CPU 30 records the image signal obtained in the above-step S114 in a memory 57, and simultaneously, in step S116, after the preview image is once erased, the image signal obtained in step S114 is displayed again on a display unit 51. After that, in step S117, the CPU 30 controls the power feeding means 31, turns off the voltage impression on the liquid optical element, and a series of photographic operations are completed.

According to the present embodiment, in the lens device 40, because the CPU 30 adjusts the voltage to be impressed on the liquid optical element corresponding to the object distance and the temperature, the focusing operation can be attained without having a mechanical drive source, and because, irrespective of the temperature change, the optimum image-formation can be attained, the high quality image can be obtained although it is compact. Further, it is arbitrary that a lens for zooming is provided in the lens device 40, and the device is made a zoom lens device. Furthermore, the voltage to be impressed on the liquid optical element 1 may also be changed corresponding to a specific function in which the temperature is made a variable.

FIG. 5 is an outline structural view of an electronic camera 150 according to the second embodiment. A different point of the present embodiment from the embodiment shown in FIG. 3, is a point that a electrostatic capacity detection means is provided in place of the temperature sensor. In the present embodiment, by using that the electrostatic capacity of the liquid optical element 1 is changed corresponding to the temperature change, the temperature is detected, and the change of optical characteristic is corrected.

When the different point is described more specifically, respectively, the amplifier 34 is connected to the transparent electrode 3 which is the second electrode of the liquid optical element 1, through an LC serial resonance circuit 62 of the electrostatic capacity detection means 61, and the amplifier 35 is connected to the bar-like electrode 25 which is the first electrode of the liquid optical element 1.

A mode of the electrostatic capacity detection by the electrostatic capacity detection means 61, will be described below. When the AC drive voltage E0 of a predetermined frequency f0 is impressed from the power feeding means 31 having the output impedance Z0 on the bar-like electrode 25 which is the first electrode of the liquid optical element 1 having the unknown electrostatic capacity, the current i0 flowed out from the transparent electrode 3 which is the second electrode of the liquid optical element 1 is flowed in the LC serial resonance circuit 62 having the impedance Zs, and a detection voltage Es is generated at the mid point of the LC serial resonance circuit 62. This detection voltage Es is proportional to the current i0. Then, the detection voltage Es at the mid point of the LC serial resonance circuit 62 is amplified by the amplifier 63 by A times, and the detection voltage A x Es of the amplifier 63 is converted into the DC voltage by the AC/DC conversion means 64, and supplied to the CPU 30. The optical element 1 is an element having the capacitance structure, and its electrostatic capacity is variable to the impressed voltage, and as the impressed voltage is higher, the electrostatic capacity also becomes high. For example, in the condition that the ambient temperature of the lens device 40 is a predetermined temperature T0 ° C., when the predetermined drive voltage E1 is impressed by the power feeding means 31, the shape of the interface 24 of the optical element 1 is changed, and because its electrostatic capacity becomes C1, the detection voltage becomes Es1. However, when the ambient temperature is changed from the predetermined temperature TO ° C., even when the same predetermined drive voltage El is impressed, because the electrostatic capacity is also changed due to the temperature, the detection voltage Es is also changed when the electrostatic capacity is changed.

Accordingly, the relationship of each temperature and detection voltage Es when a predetermined drive voltage E1 is impressed on the optical element 1, is previously detected, and when it is stored as a table of the temperature-detection voltage Es, the temperature can be detected. When a predetermined drive voltage Es is impressed on the optical element 1 at the time of temperature detection, and the detection voltage Es is detected, the CPU 30 detects the temperature at the time, and further, can determine, according to Table 1, the impression voltage onto the liquid optical element 1. Further, herein, although the serial resonance circuit is used as the detection means of the electrostatic capacity, a parallel bridge used for the LCR meter well known as the electrostatic capacity detection device, may also be used.

It is to be noted that various changes and modifications will be apparent to those skilled in the art. Therefore, unless such changes and modifications depart from the scope of the present invention, they should be construed as being included therein.

The optical lens system of the present invention can be applied to a silver halide camera or electronic camera, cell phone, image pick-up device mounted on the portable terminal such as PDA, irrespective of its use.

1. A optical lens system comprising:
a) a liquid optical element including:
i) a first liquid having conductivity,
ii) a second liquid, which is insoluble to the first liquid,
iii) a sealing container sealing the first liquid and the second liquid so that an interface of the first liquid and the second liquid has a predetermined shape,
iv) a first electrode provided in the first liquid,
v) a second electrode provided in the sealed container, and
vi) a voltage-applying device to apply a voltage between the first electrode and the second electrode for changing the shape of the interface of the first liquid and the second liquid so as to change a refractive power of the liquid optical element;
b) a plastic lens having an optical characteristic being capable of varying due to a temperature change;
c) a temperature detector to detect a temperature of a predetermined portion in the optical lens system; and
d) a voltage-controlling device to control the voltage in accordance with the temperature detected by the temperature detector so that an influence due to a change of the optical characteristic of the plastic lens and the liquid optical element is decreased.

2. A optical lens system comprising:
a) a liquid optical element including:
i) a first liquid having conductivity,
ii) a second liquid, which is insoluble to the first liquid,
iii) a sealing container sealing the first liquid and a second liquid so that an interface of the first liquid and the second liquid has a predetermined shape,
iv) a first electrode provided in the first liquid,
v) a second electrode provided in the sealed container, and
vi) a voltage-applying device to apply a voltage between the first electrode and the second electrode for changing the shape of the interface of the first liquid and the second liquid so as to change a refractive power of the liquid optical element;
b) a plastic lens having an optical characteristic being capable of varying due to a temperature change;
c) an electrostatic capacity detector to detect a electrostatic capacity of a predetermined portion in the liquid optical element; and
d) a voltage-controlling device to control the voltage in accordance with the electrostatic capacity detected by the electrostatic capacity detector so that an influence due to the change of the optical characteristic of the plastic lens and the liquid optical element is decreased.
